(19) United States
(12) Patent Application Publication
(10) Pub. No.: US 2015/0256918 A1
(43) Pub. Date: Sep. 10, 2015

(54) HEADPHONE

(71) Applicant: INNOVATION SOUND TECHNOLOGY CO., LTD., Shenzhen, Guangdong (CN)

(72) Inventor: Shunming Yuen, Hong Kong (CN)

(73) Assignee: INNOVATION SOUND TECHNOLOGY CO., LTD., Shenzhen, Guangdong (CN)

(21) Appl. No.: 14/438,767

(22) PCT Filed: Oct. 26, 2012
(86) PCT No.: PCT/CN2012/083568

§ 371 Date: Apr. 27, 2015

(51) Int. Cl. H04R 1/10

(52) U.S. Cl. CPC H04R 1/10

(57) ABSTRACT

The utility model provides a headphone, comprising a headband, left and right two ear pads and a holder. Two ends of the headband are separately provided with a fixing component, the fixing component includes a conductor block; the holder is made of the conductive material, of which one end is respectively connected with the left and right two ear pads fixedly and the other end is respectively connected with the fixing components in a sliding way, and the conductor block is pressed against the holder; in the ear pads, the first group of signal wires is connected to the holder electrically; in the fixing components, the second group of signal wires is connected with the conductor block electrically. The headphone provided in the utility model replaces the exposed lead with the conductive holder which is used as the medium for the audio signal transfer between the left and right two ear pads, thus eliminating the exposed lead on the headphone, simplifying the structure and avoiding the risk of broken circuit due to the damage of the exposed lead in use previously.

### FIELD OF THE INVENTION

The utility model relates to an earphone, in particular to a headphone.

### BACKGROUND OF THE INVENTION

The existing headphone, as shown FIG. 1 comprises left and right two ear pads 1′, a headband 2′ and a holder 3′. The ear pads 1′ separately cover the ears of the user and are internally provided with speakers for playing audio to the ears of the user. The headband 2′ is designed to be approximately arched to suit the human head outline, of which two ends are respectively provided with a fixing component 4′, one end of the holder 3′ passes through the fixing component 4′ to connect with the fixing component 4′ in a relatively sliding way, the other end of the holder 3′is connected with the ear pad 1′. The holder 3′can slide on the fixing component 4′ to drive the ear pads 1′ to slide such that different users can adjust the relative position of the left, right two ear pads 1′ to the headband 2′ to suit their head outline and position of ears.

In said headphone, the transfer of the audio signal is achieved via the lead, wherein, the earphone plug (not shown) is inserted into the audio player, computer, MP3, for example, the received audio signals are input into the ear pads 1′ through the earphone plug interface 6′ via the left, right audio signal wires and the common ground wire. Specifically, the earphone plug interface 6′ arranged on the left ear pad, for example, the left channel audio signal wire and the common ground wire are connected with the speaker in the left ear pad electrically, and the right channel audio signal wire and the common ground wire are connected to the speaker in the right ear pad electrically meanwhile. In the headphone as shown in FIG. 1, electrically connecting the right channel audio signal wire and the common ground wire with the speaker in the right ear pad is achieved as follows: the lead 5′ (the lead herein refers to the cable containing the audio signal wire and the common ground wire and externally wrapped with the insulating wrapper) penetrates out from the left ear pad and extends into the headband 2′ through the fixing component 4′ at the left side, then, penetrates out from the other end of the headband 2′ and extends into the right ear pad 1′ through the fixing component 4′ at the right side.

However, there are following disadvantages in the headphone with the structure: the lead 5′ between the left, right two ear pads 1′ and the headband 2′ are exposed so the structure is complex and disordered. In addition, due to the repeatedly sliding, stretching and contracting of the holder 3′ and the put-on or take-off operation of the user, the exposed lead 5′ is pulled and bent frequently therewith, when the number reaches a certain level, the lead 5′ is easy to damage to cause the broken circuit and further influence the use of the earphone.

### DESCRIPTION OF THE INVENTION

The technical issue to be solved by the utility model is providing a simple headphone that is not easy to turn off.

To solve the technical issue, the utility model provides a headphone, comprising a headband, left and right two ear pads and a holder. Two ends of the headband are separately provided with a fixing component, the fixing component includes a conductor block; the holder is made of the conductive material, of which one end is respectively connected with the left and right two ear pads fixedly and the other end is respectively connected with the fixing components in a sliding way, and the conductor block is pressed against the holder; in the ear pads, the first group of signal wires is connected to the holder electrically; in the fixing components, the second group of signal wires is connected with the conductor block electrically.

Furthermore, the holder includes the first slide way and the second slide way; at least one conductor block is pressed against the first slide way and the second slide way respectively.

Furthermore, each of the first group of signal wires and second group of signal wires includes an audio signal wire and a common ground wire, wherein the audio signal wire in the first group of signal wires is electrically connected with the first slide way of the holder, the audio signal wire in the second group of signal wires is electrically connected with the conductor block pressed against the first slide way; the common ground wire in the first group of signal wires is electrically connected with the second slide way of the holder, and the common ground wire in the second group of signal wires is electrically connected with the conductor block on the second slide way.

Furthermore, the audio signal wires are the left channel audio signal wire or the right channel audio signal wire.

Furthermore, both the holder and conductor block are made of metal.

Furthermore, the fixing component further includes a holder fixing seat and a pivot fixing cover, the holder fixing seat can be rotatably connected with the pivot fixing cover, and the holder is connected with the holder fixing seat in a sliding way.

Furthermore, the holder fixing seat includes a holder fixing upper seat and a holder fixing lower seat, the holder fixing upper seat is opened, the holder fixing lower seat is slotted on the corresponding position, the first slide way and second slide way of the holder are respectively arranged in the slot and pass through the opening.

Furthermore, the fixing component further includes a spring sleeved on the conductor block, one end of the spring is fixedly connected with the slot, the conductor block further comprises a pressing part and a sleeving part, the pressing part is pressed against the slide way accommodated in the slot and the sleeving part is accommodated in the spring.

Furthermore, the pivot fixing cover includes a pivot fixing lower cover and a pivot fixing upper cover, the pivot fixing lower cover includes a lower locking plate, two ends of the lower locking plate at the same side are respectively added with an end cover, the holder fixing seat is accommodated between the two end covers, the pivot fixing upper cover includes an upper locking plate, a connecting arm extends out from two ends of the upper locking plate at the same side respectively, and the connecting arms are connected with the end covers.

Furthermore, the end of the headband is fixedly connected between the upper locking plate and the lower locking plate.

The headphone provided in the utility model replaces the exposed lead with the conductive holder as the medium for the audio signal transfer between the left and right two ear pads, thus eliminating the exposed lead on the headphone, simplifying the structure and avoiding the risk of broken circuit due to the damage of the exposed lead in use previously.

### BRIEF INTRODUCTION OF THE DRAWINGS

To describe the technical solution in the embodiments of the utility model or in the prior art, the necessary drawings in the embodiments or the prior art are briefly introduced, obviously, the drawings described below are only some embodiments of the utility model, the skilled in the art can obtain the other drawings based on the drawing without paying the creative work.

FIG. 1 is the structural schematic view of the existing headphone.

FIG. 2 is the structural principle schematic view of the present headphone in the embodiments of the utility model.

FIG. 3 is the structural schematic view of the present headphone in the embodiments of the utility model.

FIG. 4 is the assembly stereogram of the fixing component and holder of the headphone in the embodiments of the utility model.

FIG. 5 is the cross-section schematic view along A-A as shown in FIG. 4.

FIG. 6 is the exploded assembly stereogram of the fixing component and holder of the headphone in the embodiments of the utility model.

### DETAILED DESCRIPTION OF THE PREFERRED EMBODIMENTS

The preferred embodiments of the utility model are described with referring to the drawing as follows.

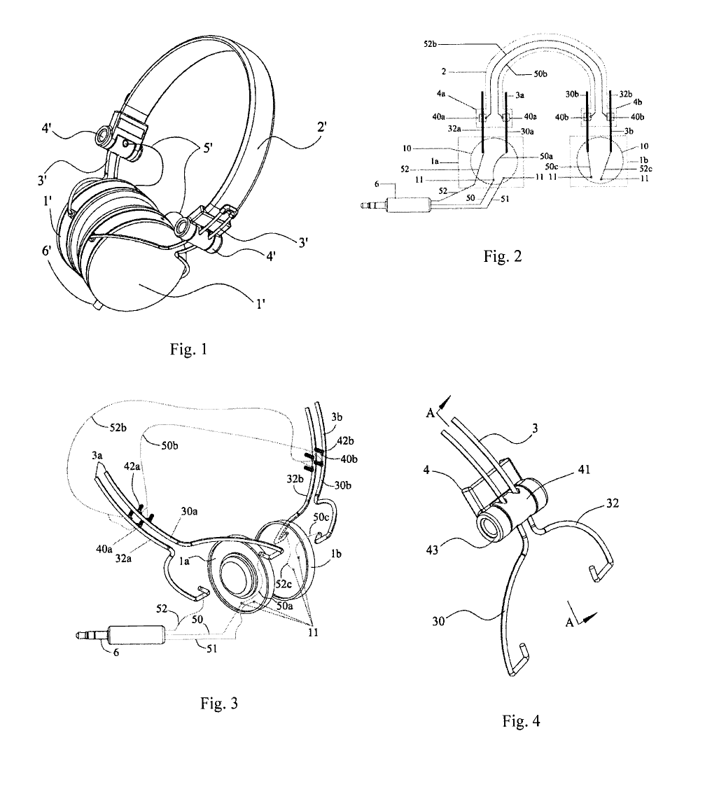

The headphone in the embodiment of the utility model, based on the structure of the existing headphone as shown in FIG. 1, replaces the exposed lead 5′ with the conductive holder as the medium for the audio signal transfer between the left and right two ear pads, thus eliminating the exposed lead on the headphone, simplifying the structure and avoiding the risk of broken circuit due to the damage of the exposed lead in use previously.

The structural principle schematic view of the headphone in the embodiments of the utility model is as shown in FIG. 2. One end of the earphone plug 6 is electrically connected with the audio player, and the received audio signals are input into the ear pads through the signal wire. With using the audio signal firstly transferred to the left ear pad 1a as an example, the signal wires includes a common ground wire 50, a left channel audio signal wire 51 and a right channel audio signal wire 53. The left ear pad 1a is internally provided with a speaker 10, the common ground wire 50 and the left channel signal wire 51 are respectively electrically connected with the speaker 10 in the left ear pad 1a through the welding spot 11 so as to provide the audio signal for the left ear pad 1a and make the user hear the audio through the left ear pad 1a. Meanwhile, to make the right ear pad 1b also provide the audio signal and the user hear the audio through the right ear pad 1b, it is necessary to transfer the signals of the common ground wire 50 and the right channel audio signal wire to the right ear pad 1b. The embodiments of the utility model are as follows: the holder 3a includes two slide ways 30a, 32a each having a sliding end and fixed end, wherein the sliding end is connected with the fixing component 4a in a sliding way, the fixed end extends into the left ear pad 1a and connected with the left ear pad fixedly. The right channel audio signal wire 52 is electrically connected with the fixed end of the first slide way 32a via the lead (for description convenience, the lead is called as the right channel audio signal wire 52a), and the common ground wire 50 is electrically connected to the fixed end of the second slide way 30 from the welding spot 11 (whether four welding spots 11 should be respectively numbered) (for description convenience, the lead is called as the common ground wire 50a) respectively, both the slide ways are conductive such that the whole slide ways 30a, 32a are respectively used as the extension of the common ground wires (50, 50a) and right channel audio signal wire 52 in the left ear pad 1a to transfer the signals out of the left ear pad 1a through the slide ways 30a, 32a. The fixing component 4a is internally provided with a conductor block 40a which is pressed against the slide ways 30a, 32a of the holder 3a, due to the sliding connection between the holder 3a and the fixing component, when the holder slides relative to the fixing component 4a, the slide ways 30a, 32a always keeps the sliding contact with the conductor block 40a, thus the conductor block 40a can obtain the signals from the slide ways 30a, 32a. The conductor block 40a is further connected with the lead, the slide way 30a is used as the extension of the common ground wires (50,50a) in the left ear pad 1a, so the part of the lead connected with the conductor block is also called as the common ground wire, for description convenience, the part of the common ground wire is marked as 50b; similarly, the lead connected with the conductor block 40a pressed against the slide way 32a is also called as the right channel audio signal wire 52b. Both the common ground wire 50b and the right channel audio signal wire 52b are arranged in the headband, and the headband is designed to be the approximately arched shape to suit the human head outline.

The other end of the headband 2 is equipped with a fixing component 4b that is exactly the same with the fixing component 4a in structure. One end of the conductive holder 3b that is exactly the same with the holder 3a in structure passes through the fixing component 4b and is connected with the fixing component 4b in a relative sliding way, the other end of the holder 3b is connected with the right ear pad 1b. the fixing component 4b is provided with a conductor block 40b which is respectively connected with the common ground wire 50b and the right channel audio signal wire 52b electrically. The holder 3b is connected with the fixing component 4b in a sliding way, the conductor block 40b is pressed against the holder 3b, when the holder 3b slides relative to the fixing component 4b, the holder 3b always keeps the sliding contact with the sliding contact with the conductor block 4b. Specifically, the holder 3b includes two slide ways 30b, 32b, the conductor block 40b are respectively pressed against the slide ways 30b, 32b. In this way, the signals obtained by conductor block 40b from the common ground wire 50b and the right channel audio signal wire can be separately transferred to the slide ways 30b and 32b. Like the slide ways 30a, 32a of the holder 3a, the slide ways 30b, 32b of the holder 3b are used as the medium of the signal transfer. The tail ends extends into the right ear pad 1b from the slide ways 30b, 32b are respectively connected with the lead electrically, namely the common ground wire 50c, the right channel audio signal wire 52c are connected with the speaker 10 in the right ear pad 1b through the welding spot 11 electrically. Thus, the signal is transferred from the left ear pad 1a to the right ear pad 1b and the user can hear the audio through the right ear pad. For example, the right channel audio signal can be transferred from the left ear pad 1a to the right ear pad, as it were, through the lead 52, the slide way 32a, the lead 52b, the slide way 32b and the lead 52c respectively, or through the leads between the left and right ear pads, only the lead between the ear pad and the fixing component is replaced with the slide way of the holder. In the same way, so is the common ground wire.

FIG. 3 is the specific structural schematic view provided based on the principle as shown in FIG. 2. As with the FIG. 2, the audio signal is firstly transferred to the left ear pad 1a through the earphone plug 6, for example, the signal wire includes the common ground wire 50, the left channel audio signal wire 51 and the right channel audio signal wire 52. The left ear pad 1 a is internally equipped with the speaker, the common ground wire 50 and the left channel audio signal wire 51 are electrically connected with the speaker in the left ear pad 1a through the welding spot 11 so as to provide the audio signal to the left ear pad 1a and make the user hear the audio through the left ear pad 1a. The holder 3a includes two slide ways 30a, 32a each having a sliding end and fixed end, wherein the sliding end is connected with the fixing component (not shown) in a sliding way, the fixed end extends into the left ear pad 1a and connected with the left ear pad fixedly. The sliding ends of the two slide ways 30a, 32a are parallel to each other and the spacing length thereof suits the fixing component; the fixed end is outwards protruded and slightly arched to suit the outline of the left ear pad 1a. In the left ear pad 1a, the right channel audio signal wire 52 is directly electrically connected with the fixed end of the slide way 32a, the common ground wire 50a is led out from the welding spot 11 and electrically connected with the fixed end of the slide way 30a. At least one conductor block 40a is pressed against the sliding ends of the slide ways 30a, 32a, as shown in FIG. 3, there are two conductor blocks 40a pressed against the sliding ends of the slide ways 30a, 32a respectively. Two conductor blocks 40a on the same slide way are respectively electrically connected with two leads that are combined into one lead for transfer, for example, two leads electrically connected with the two conductor blocks 40a on the slide way 30a are combined into the common ground wire 50b; the two leads electrically connected with the two conductor blocks 40a on the slide way 32a are combined into the right channel audio signal wire 52b, the advantage thereof compared with one conductor arranged on one slide way is: when the lead and one conductor block are poor contact or the conductor block falls off etc., the other conductor block can still obtain the electric signal from the slide way so as to ensure the smoothness of the signal transfer. The conductor block 40a is sleeved by the spring 42a externally, the conductor block 40a is closely pressed against the slide way via the elasticity of the spring 42a, so the two parts are adhered tightly and always keep the contact during the sliding process, thus the conductor block 40a can obtain the electric signal from the slide way normally. Two leads are respectively divided from the portions on the right channel audio signal wire 52b and the common ground wire 50b closing to the conductor block and electrically connected to the slide ways 32b and 30b, for example, the two leads divided from the right channel audio signal wire 52b are respectively electrically connected to the two conductor block 40b on the slide way 32b; the two leads divided from the common ground wire 50b are respectively electrically connected to the two conductor block 40b on the slide way 32b. in the right ear pad 1b, one end of one lead is electrically connected with the fixed end of the slide way 32b to obtain the electric signal from the slide way 32b and the other end is electrically connected with the speaker in the right ear pad 1b, the lead is the right channel audio signal wire 52c. One end of the other lead is electrically connected with the fixed end of the slide way 30b to obtain the electric signal from the slide way 30b and the other end is connected with the speaker in the right ear pad 1b electrically, the lead is the common ground wire 50c.

To be sure, the left ear pad 1a and the right ear pad 1b, the holders 3a and 3b, the slide ways 30a, 30b, 32a, 32b, the fixing components 4a and 4b, the conductor blocks 40a and 40b, the springs 42a and 42b are the same in structure, which are marked and distinguished by a and b to make the corresponding description more clear.

As mentioned above, the connection relationship of the leads, slide ways and conductor blocks is: in the left ear pad or the right ear pad, the first group of signal wire is electrically connected with the holder 3; in the fixing component 4, the second group of signal wire is electrically connected with the conductor block 40. Specifically, both the first group of signal wires and the second group of signal wires include an audio signal wire and a common ground wire respectively, wherein the audio signal wire in the first group of signal wires is electrically connected with the first slide way 32 of the holder 3, the audio signal wire in the second group of signal wires is electrically connected with the conductor block 40 pressed against the first slide way 32; the common ground wire in the first group of signal wires is electrically connected with the second slide way 30 of the holder 3, and the common ground wire in the second group of signal wires is electrically connected with the conductor block 40 on the second slide way 30. The second group of signal wires is arranged in the headband 2. Certainly, as for the headphone provided in the embodiments of the utility model, there are two first groups of signal wires which are separately arranged in the left ear pad and the second ear pad. If the audio signal in the first group of signal wires is the right channel audio signal wire, the left channel audio signal wire is directly electrically connected with the speaker in the left ear pad, the right channel audio signal wire is electrically connected with the first slide way of the left holder (connected with the left ear pad) in the left ear pad, the audio signal wire in the second group of signal wires is also the right channel audio signal wire of which one end is electrically connected with the conductor block pressed against the first slide way in the left fixing component (connected with the left holder) and the other end is electrically connected with the conductor block on the first slide way pressed against the right holder (connected with the right ear pad) in the right fixing component (connected with the right holder). If the audio signal wire in the first group of signal wires is the left channel audio signal wire, the situation is similar so as to repeat no more here.

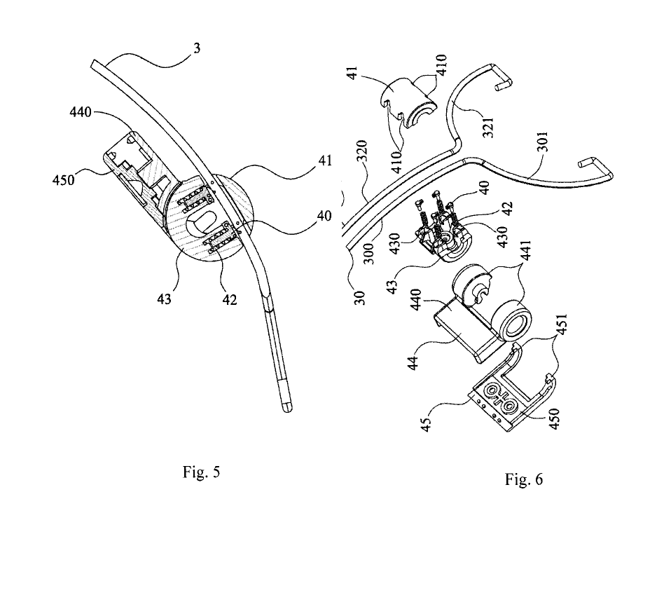

Please refer to FIG. 4-6 at the same time, FIG. 4 is the assembly stereogram of the fixing component and holder of the headphone in the embodiments of the utility model; FIG. 5 is the cross-section schematic view along A-A as shown in FIG. 4; FIG. 6 is the exploded assembly stereogram of the fixing component and holder of the headphone in the embodiments of the utility model.

The fixing component 4 includes a holder fixing seat and a pivot fixing cover, the holder fixing seat is cylindrical and further includes a holder fixing upper seat 41 and a holder fixing lower seat 43, the pivot fixing cover further includes a pivot fixing lower cover 44 and a pivot fixing upper cover 45.

The slide way 30 of the holder 3 includes a sliding end 300 and a fixed end 301, the slide way 32 includes a sliding end 320 and a fixed end 321, wherein the holder fixing upper seat 41 and holder fixing lower seat 43 can be locked to accommodate the sliding ends 300 and 320 therein, and the sliding ends 300 and 320 can slide in the holder fixing seat to and fro. The top and bottom of the holder fixing upper seat 41 are respectively opened 410 and the holder fixing lower seat 43 is slotted on the corresponding positions. The conductor block 40 includes a pressing part and a sleeving part, the pressing part is pressed against the sliding end of the slide way and the sleeving part is arranged in the spring 42, one end of the spring 42 is fixedly connected with the slot 430. When the holder fixing upper seat 41 and the holder fixing lower seat 43 are locked, the sliding ends 300 and 320 of the holder 3 are placed in the slot 430, the conductor block 40 sleeved with the spring 42 is arranged between the sliding ends 300 and 320 and the slot 430. Due to the locking function of the holder fixing seat, the spring 42 is pressed so that the pressing part of the conductor block 40 is pressed against the sliding ends 300 and 320 tightly. The sliding ends 300 and 320 respectively penetrate out from the opening 410 so as to achieve the sliding connection between the holder 3 and the fixing component 4, the sliding ends 300 and 320 always keep the close contact with the conductor block 40 during the sliding process.

The pivot fixing lower cover 440 includes a rectangular lower locking plate 440, two ends at the same side of the pivot fixing lower cover 440 are respectively provided with a circular end cover 441, the space between the two end covers 441 is used for accommodating the holder fixing seat. The semicircular holes on two ends of the holder fixing upper seat 41 and a holder fixing lower seat 43 separately clamp the hollow plastic shafts extending from the two end covers 441 so that the holder fixing seat can rotate around the pivot fixing cover and further drive the holder and ear pads to rotate, thus the user can adjust based on the wearing habit. The pivot fixing upper cover 45 includes a rectangular upper locking plate 450, an arched connecting arm 451 respectively extends out from two ends at the same side of the upper locking plate 450, and the connecting arms 451 are connected with the end covers 441. When the pivot fixing upper cover 45 and the pivot fixing lower cover 44 are locked, the upper locking plate 450 and the lower locking plate 440 can fix the end of the headband 2 therebetween, thus the fixing component 4 is fixedly connected with the headband.

The disclosure mentioned above is the preferred embodiments of the utility model only and cannot limit the scope of claims of the utility model, therefore, the equivalent changes based on the claims of the utility model are still to be embraced within the scope of the utility model.

1. A headphone, comprising a headband, left and right two ear pads and a holder, wherein two ends of the headband are separately provided with a fixing component, the fixing component includes a conductor block; the holder is made of the conductive material, of which one end is respectively connected with the left and right two ear pads fixedly and the other end is respectively connected with the fixing components in a sliding way, and the conductor block is pressed against the holder; in the ear pads, the first group of signal wires is connected to the holder electrically; in the fixing components, the second group of signal wires is connected with the conductor block electrically.

2. The headphone as claimed in claim 1, wherein the holder includes the first slide way and the second slide way; at least one conductor block is pressed against the first slide way and the second slide way respectively.

3. The headphone as claimed in claim 2, wherein each of the first group of signal wires and second group of signal wires includes an audio signal wire and a common ground wire, wherein the audio signal wire in the first group of signal wires is electrically connected with the first slide way of the holder, the audio signal wire in the second group of signal wires is electrically connected with the conductor block pressed against the first slide way; the common ground wire in the first group of signal wires is electrically connected with the second slide way of the holder, and the common ground wire in the second group of signal wires is electrically connected with the conductor block on the second slide way.

4. The headphone as claimed in claim 3, wherein the audio signal wires are the left channel audio signal wire or the right channel audio signal wire.

5. The headphone as claimed in claim 1, wherein both the holder and conductor block are made of metal.

6. The headphone as claimed in claim 2, wherein the fixing component further includes a holder fixing seat and a pivot fixing cover, the holder fixing seat can be rotatably connected with the pivot fixing cover, and the holder is connected with the holder fixing seat in a sliding way.

7. The headphone as claimed in claim 6, wherein the holder fixing seat includes a holder fixing upper seat and a holder fixing lower seat, the holder fixing upper seat is opened, the holder fixing lower seat is slotted on the corresponding position, the first slide way and second slide way of the holder are respectively arranged in the slot and pass through the opening.

8. The headphone as claimed in claim 7, wherein the fixing component further includes a spring sleeved on the conductor block, one end of the spring is fixedly connected with the slot, the conductor block further comprises a pressing part and a sleeving part, the pressing part is pressed against the slide way accommodated in the slot and the sleeving part is accommodated in the spring.

9. The headphone as claimed in claim 6, wherein the pivot fixing cover includes a pivot fixing lower cover and a pivot fixing upper cover, the pivot fixing lower cover includes a lower locking plate, two ends of the lower locking plate at the same side are respectively added with an end cover, the holder fixing seat is accommodated between the two end covers, the pivot fixing upper cover includes an upper locking plate, a connecting arm extends out from two ends of the upper locking plate at the same side respectively, and the connecting arms are connected with the end covers.

10. The headphone as claimed in claim 9, wherein the end of the headband is fixedly connected between the upper locking plate and the lower locking plate.
